(19) United States
(12) Patent Application Publication
(10) Pub. No.: US 2015/0326002 A1
(43) Pub. Date: Nov. 12, 2015

(54) PROTECTIVE CIRCUIT

(71) Applicant: ROBERT BOSCH GMBH, Stuttgart (DE)

(72) Inventor: Wolfgang KOSTORZ, Weil Der Stadt (DE)

(21) Appl. No.: 14/651,661

(22) PCT Filed: Oct. 23, 2013
(86) PCT No.: PCT/EP2013/072134

§ 371 Date: Jun. 11, 2015

(30) Foreign Application Priority Data
Dec. 12, 2012 (DE) 10 2012 222 895.0

(51) Int. Cl. H02H 3/10; H02H 3/00

(52) U.S. Cl. CPC H02H 3/10; H02H 3/003

(57) ABSTRACT

A protective circuit includes an input, an output, a p-type field-effect transistor whose drain terminal is connected to the input and whose source terminal is connected to the output, a capacitor between the gate terminal of the field-effect transistor and ground, a Zener diode whose cathode is connected to the output, a resistor between the anode of the Zener diode and ground, and a diode whose anode is connected to the anode of the Zener diode and whose cathode is connected to the gate terminal of the field-effect transistor.

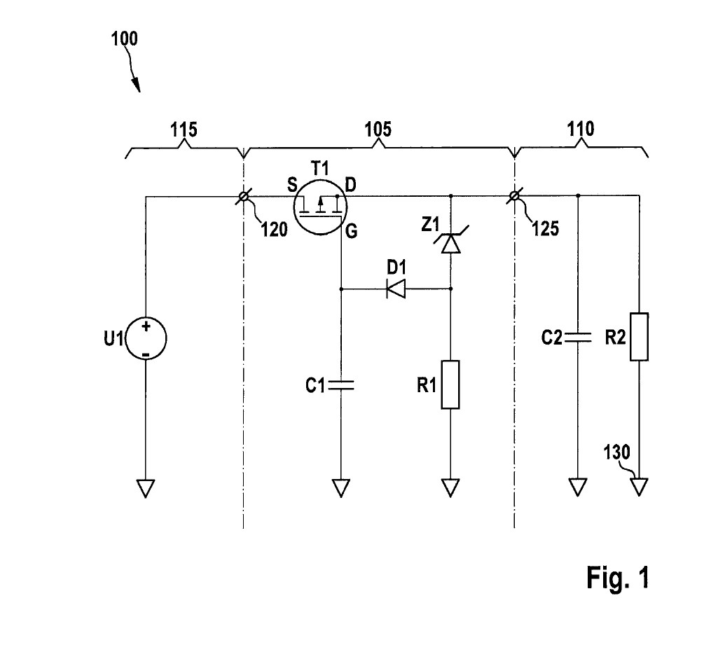

### FIELD OF THE INVENTION

The present invention relates to a protective circuit. In particular, the invention relates to a protective circuit for operating an electrical load on board a motor vehicle.

### BACKGROUND INFORMATION

Usually a direct voltage system is used for the power supply of electrical loads on board a motor vehicle. A nominal voltage of such a direct voltage system normally lies at 12 V in an automobile or 24 V in a truck. As a rule, an electrical load is connected between a supply connection and ground to the vehicle electrical system, the electrical ground and the vehicle ground being able to be equated. If a polarity reversal happens in this context, the electrical load may suffer damage. In addition, a high current may flow, which in the simplest case, may trigger a fuse in the direct voltage system, and in the most unfavorable case, may cause damage owing to excess current at the load or in the motor-vehicle electrical system. Therefore, especially in order to connect an electrical load that is removable from the motor vehicle, e.g., a radio receiver, an entertainment system or a navigation system, electrically to the motor-vehicle electrical system, a protective circuit may be used in order to guard against such damage.

An especially simple protective circuit includes only one diode which is inserted in the forward conducting direction between the supply line and the load. The disadvantage in doing this is that a customary free-wheeling diode exhibits significant reverse voltage, so that in some circumstances, insufficient voltage is supplied to the electrical load. The reverse voltage of a silicon diode usable for this lies at approximately 0.7 V.

It has also been suggested to dispose a field-effect transistor (FET) between the supply line and the load or in the ground cable of the load, and to control it in suitable fashion. The disadvantage in this case is that a field-effect transistor is generally reverse conducting, that is, a current is able to flow from the load into the vehicle electrical system. For example, if the electrical load is equipped with a buffer capacitor, then the energy of the buffer capacitor is output to the on-board voltage network when the voltage of the on-board voltage network falls. An electrical load which is dependent on a certain after-run is thus not able to be operated. For instance, the after-run may be used to transfer a programmable microcomputer of the load into a safe state before the electrical energy stored in the buffer capacitor is used up. The after-run may also be advantageous when, for instance, an electric motor is being operated that is not supposed to be braked upon a decrease in the supply voltage.

German Published Patent Application No. 10 2009 029 514 A1 suggests that a control unit be provided with a protective circuit that includes two field-effect transistors and operates essentially according to the principle of a switching controller in order to realize one or more of the following individual functions: protection against polarity reversal, overvoltage protection, connector contact protection and primary relay.

### SUMMARY

The object of the present invention is to provide a simplified circuit for protecting an electrical load on board a motor vehicle from polarity reversal. A further object of the invention is to indicate an electrical load protected by the protective circuit.

A protective circuit according to the present invention includes an input, an output, a p-type field-effect transistor whose drain terminal is connected to the input and whose source terminal is connected to the output, a capacitor between the gate terminal of the field-effect transistor and ground, a Zener diode whose cathode is connected to the output, a resistor between the anode of the Zener diode and ground, and a diode whose anode is connected to the anode of the Zener diode and whose cathode is connected to the gate terminal of the field-effect transistor.

Advantageously, the protective circuit is only slightly reverse-conducting, so that an after-run of the load is possible when the voltage at the output of the protective circuit exceeds the voltage at its input. The circuit is easy to construct and is able to exhibit low power dissipation, resulting in negligible self-heating. The protective circuit is therefore able to be compact and inexpensive, so that it may be used for a variety of loads.

An electrical load of the present invention includes the protective circuit described, and in addition, a buffer capacitor disposed between the output of the protective circuit and ground.

The buffer capacitor is able to allow an after-run of the electrical load when the voltage at the input of the protective circuit is interrupted or temporarily has a smaller value than the voltage of the buffer capacitor. The electrical load is thereby able to remain operative at least for a short time, even if no electric energy is able to be drawn from the motor-vehicle electrical system. For example, the voltage of the vehicle electrical system can drop short-term when a combustion engine for propelling the motor vehicle is put into operation by an electric starter motor. During this time of reduced voltage, the after-run may be used, for example, to supply a programmable microcomputer of the load with voltage, so that it doesn't have to run through a time-consuming restart because the voltage is too low.

In a further specific embodiment, the load also includes an ohmic resistor connected in parallel to the buffer capacitor. The ohmic resistor is able to mirror the effective circuit of the load. The buffer capacitor may be discharged via the ohmic resistor when no more energy is flowing to the electrical load from the vehicle electrical system.

Preferably, the load is set up for use on an on-board voltage network of the motor vehicle. In particular, the load may be set up to operate with a relatively low direct voltage of less than 50 V, preferably with nominal values in the area of 12 V, 24 V, 36 V or 48 V.

### BRIEF DESCRIPTION OF THE DRAWING

The FIGURE shows a system of an electrical load and a protective circuit on an on-board voltage network of a motor vehicle.

### DETAILED DESCRIPTION

The FIGURE shows a system 100 on board a motor vehicle. System 100 includes a protective circuit 105 in order to operate a load 110 on an on-board voltage network 115. On-board voltage network 115 preferably makes a direct voltage available having a nominal value in the area of 12 V, 24 V, 36 V or 48 V. A possible residual ripple of the direct voltage of on-board voltage network 115 may be disregarded in the context given.

Electrical load 110 may be modeled as an ohmic load having a resistor R2. In one specific embodiment, connected in parallel to ohmic resistor R2 is a buffer capacitor C2 that allows operation of electrical load 110 when no electric current is flowing to electrical load 110 from on-board voltage network 115.

Protective circuit 105 includes a field-effect transistor T1, a Zener diode Z1, a diode D1, a resistor R1, an input 120 and an output 125. Hereinafter, it is assumed that on-board voltage network 115 is conducting a voltage U1.

Field-effect transistor T1 is of the p-type, that is, it conducts when the voltage at its gate terminal G is positive. Like in a known protective circuit, field-effect transistor T1 is operated as a switch. A source terminal S of field-effect transistor T1 is connected to input 120, a drain terminal D to output 125. If the voltage between gate terminal G and source terminal S increases to a sufficiently high value, field-effect transistor T1 then allows a current to flow from input 120 across source terminal S and drain terminal D to output 125. If the voltage between gate terminal G and source terminal S drops below the predetermined value, field-effect transistor T1 is then turned off, and the current flow between input 120 and output 125 is interrupted.

Between output 125 and ground 130, a voltage divider is provided which includes Zener diode Z1 in reverse direction and resistor R1 to ground. In this context, the cathode of Zener diode Z1 is connected to output 125, and from its anode, resistor R1 leads to ground 130. Ground 130 is the electrical ground of the system shown. In a customary embodiment, a mechanical ground of the motor vehicle in the form of a bodywork is connected to electrical ground 130.

The anode of diode D1 is connected to the anode of Zener diode Z1 and to resistor R1. The cathode of diode D1 leads to gate terminal G of field-effect transistor T1. In addition, capacitor C1 is connected between gate terminal G of field-effect transistor T1 and ground 130.

If protective circuit 105 is connected in the correct polarity to on-board voltage network 115, as shown in the FIGURE, with voltage U1 from input 120 to ground 130 being positive, then a small current flows across a parasitic diode, which is between drain terminal D and source terminal S of field-effect transistor T1, and further through Zener diode Z1 and diode D1 to capacitor C1 and to gate terminal G of field-effect transistor T1, whereby it becomes conductive and allows a current from input 120 to output 125 which is sufficient to operate load 110.

If the voltage applied to input 120 collapses, as may be the case, for example, upon switching off on-board voltage network 115 or during a temporary voltage dip, the voltage present at gate terminal G of field-effect transistor T1 is initially retained by capacitor C1, since a drain-off of the charge of capacitor C1 is prevented through diode D1. The voltage present at gate terminal G of field-effect transistor T1 is therefore greater than the voltage present at drain terminal D, so that field-effect transistor T1 is turned off. An appreciable current is thereby prevented from flowing from output 125 to input 120 of protective circuit 105. If load 110 possesses buffer capacitor C2, then the charge of buffer capacitor C2 is not or is scarcely discharged via protective circuit 105, and the load may continue to be operated or to coast on the basis of the charge of buffer capacitor C2.

If electrical load 110 includes an electric motor which is still in motion, the electrical energy which it makes available upon switch-off of the supply voltage is then not able to drain off into on-board voltage network 115. The electric motor is therefore not electrically braked and is able to coast for a prolonged period of time.

Should it be that electrical load 110 together with protective circuit 105 are connected in false polarity to on-board voltage network 115, so that the voltage between input 120 of protective circuit 105 and ground 130 is negative, then a current flows across resistor R1 and diode D1 to gate terminal G and charges capacitor C1. The voltage at gate terminal G of field-effect transistor T1 is then greater than the voltage at drain terminal D, so that field-effect transistor T1 is turned off No appreciable current then flows any longer between input 120 and output 125, so that electrical load 110 cannot be operated in reversed polarity.

1.-4. (canceled)

5. A protective circuit, comprising:
an input;
an output;
a p-type field-effect transistor including a drain terminal connected to the input and including a source terminal connected to the output;
a capacitor connected between a gate terminal of the field-effect transistor and ground;
a Zener diode including a cathode connected to the output;
a resistor connected between an anode of the Zener diode and ground; and
a diode including an anode connected to the anode of the Zener diode and including a cathode connected to the gate terminal of the field-effect transistor.

6. An electrical load, comprising:
a protective circuit, including:
an input,
an output,
a p-type field-effect transistor including a drain terminal connected to the input and including a source terminal connected to the output,
a capacitor connected between a gate terminal of the field-effect transistor and ground,
a Zener diode including a cathode connected to the output,
a resistor connected between an anode of the Zener diode and ground, and
a diode including an anode connected to the anode of the Zener diode and including a cathode connected to the gate terminal of the field-effect transistor; and
a buffer capacitor disposed between the output of the protective circuit and ground.

7. The load as recited in claim 6, further comprising an ohmic resistor connected in parallel to the buffer capacitor.

8. The load as recited in claim 6, wherein the load is set up for use on an on-board voltage network of a motor vehicle.
